(19) United States
(12) Patent Application Publication
(10) Pub. No.: US 2025/0164643 A1
(43) Pub. Date: May 22, 2025

(54) IN-VEHICLE DETECTION APPARATUS

(71) Applicant: Honda Motor Co., Ltd., Tokyo (JP)

(72) Inventors: Hidetoshi Utsumi, Wako-shi (JP); Fumihiro Aoki, Wako-shi (JP); Shuhei Masuoka, Utsunomiya-shi (JP); Shunsuke Konishi, Wako-shi (JP)

(21) Appl. No.: 18/950,328

(22) Filed: Nov. 18, 2024

(30) Foreign Application Priority Data
Nov. 21, 2023 (JP) 2023-197326

(51) Int. Cl. G01S 17/931; G01S 7/481; G01S 17/48; G06T 7/521; G06V 20/56; G06V 20/58

(52) U.S. Cl. CPC G01S 17/931; G01S 7/4815; G01S 7/4817; G01S 17/48; G06T 7/521; G06V 20/58; G06V 20/588; G06T 2207/10028

(57) ABSTRACT

An in-vehicle detection apparatus includes a first scanning unit scanning and irradiating optical signals in a first direction and a second scanning unit scanning and irradiating optical signals in a second direction intersecting the first direction. At least one of the first and second scanning units includes: a first optical branching unit configured to selectively switch a destination to which each of the optical signals from a plurality of light sources is output to one of output destinations of a plurality of channels, a crossing unit configured to cross at least some optical signals among the optical signals output from the first optical branching unit, and a second optical branching unit configured to receive the optical signals output from the crossing unit, and selectively switch a destination to which each of the optical signals is output to one of output destinations of a plurality of channels.

### CROSS-REFERENCE TO RELATED APPLICATION

This application is based upon and claims the benefit of priority from Japanese Patent Application No. 2023-197326 filed on Nov. 21, 2023, the content of which are incorporated herein by reference.

### BACKGROUND OF THE INVENTION

### Field of the Invention

This invention relates to an in-vehicle detection apparatus for detecting an object or measuring a distance to the object.

### Description of the Related Art

A light detection and ranging (LiDAR) is known as a key device that supports self-driving technology. The LiDAR performs scanning while changing an irradiation angle of a laser beam to be emitted in two axial directions, and detects an object or measures a distance to the object, and the like based on position information of each detection point.

For example, JP 2022-517857 A discloses a LiDAR system that operates a demultiplexing element such as an optical phased array (OPA) in order to irradiate different sample regions in a field of view with laser beams.

In general, in a case where a LiDAR is mounted on an automobile or the like, it is necessary to irradiate several hundred or more irradiation points with laser beams per axis. In a case where the conventional technology is used, the demultiplexing elements, each selectively outputting a laser beam from one of output terminals of two channels, are stacked, and several hundred or more output terminals are only switched one by one, making it difficult to densely output the laser beams from the plurality of output terminals at the final stage.

### SUMMARY OF THE INVENTION

An aspect of the present invention is an in-vehicle detection apparatus including a first scanning unit configured to scan and irradiate optical signals in a first direction, and a second scanning unit to scan and irradiate optical signals in a second direction intersecting the first direction, and configured to detect an external environment situation by scanning and irradiating the optical signals in a field of view. At least one of the first scanning unit and the second scanning unit includes: a first optical branching unit configured to selectively switch a destination to which each of the optical signals from a plurality of light source is output to one of output destinations of a plurality of channels;

a crossing unit configured to cross at least some optical signals among the optical signals output from the first optical branching unit; and a second optical branching unit configured to receive the optical signals output from the waveguide crossing unit, and selectively switch a destination to which each of the optical signals is output to one of output destinations of a plurality of channels.

### BRIEF DESCRIPTION OF THE DRAWINGS

The objects, features, and advantages of the present invention will become clearer from the following description of embodiments in relation to the attached drawings, in which:

FIG. 1A is a diagram showing how a vehicle drives on a road;

FIG. 1B is a schematic diagram showing an example of detection data obtained by a LiDAR;

FIG. 2 is a block diagram illustrating a configuration of a main part of a vehicle control device;

FIG. 3 is a schematic diagram for explaining irradiation points by the LiDAR;

FIG. 4 is a schematic diagram exemplifying a configuration of the LiDAR according to an embodiment;

FIG. 5 is a block diagram illustrating a configuration of a main part of a vertical scanning mechanism in which the transceiver of FIG. 4 and the vertical scanning mechanism are integrated;

FIG. 6 is a schematic diagram illustrating an overall configuration of a transmission light branching unit extracted from exemplified in FIG. 5;

FIG. 7 is a diagram for explaining the light source and the first switch group in FIG. 6;

FIG. 8 is a diagram for explaining the waveguide crossing unit in FIG. 6;

FIG. 9 is a diagram for explaining the second switch group in FIG. 6;

FIG. 10 is a flowchart showing an example of processing executed by a CPU of the controller in FIG. 2;

FIG. 11 is a diagram for explaining the light source and the first switch group in a third modification;

FIG. 12 is a diagram for explaining the waveguide crossing unit in the third modification; and

FIG. 13 is a diagram for explaining the second switch group in the third modification.

### DETAILED DESCRIPTION OF THE INVENTION

Hereinafter, an embodiment of the invention will be described with reference to the drawings.

First, an external environment recognition device using a LiDAR device (hereinafter referred to as a LiDAR) as an in-vehicle detection apparatus according to the embodiment of the invention and a vehicle on which the external environment recognition device is mounted will be described.

The external environment recognition device can be mounted on a vehicle having a self-driving capability, that is, a self-driving vehicle. Note that, in the embodiment, the vehicle on which the external environment recognition device is mounted may be referred to as a subject vehicle to be distinguished from other vehicles. The subject vehicle may be any of an engine vehicle having an internal combustion engine (engine) as a driving power source, an electric vehicle having a driving motor as a driving power source, and a hybrid vehicle having an engine and a driving motor as a driving power source. The subject vehicle is capable of driving not only in a self-drive mode that does not require a driver's driving operation but also in a manual drive mode that requires a driver's driving operation.

While the self-driving vehicle is driving in the self-drive mode (hereinafter referred to as self-driving or autonomous driving), the self-driving vehicle recognizes an external environment situation around the subject vehicle, based on detection data of the in-vehicle detection apparatus such as a LiDAR or a camera. The self-driving vehicle generates a driving path (a target path) for a predetermined period of time from the current time based on the recognition result, and controls a driving actuator so that the subject vehicle drives along the target path.

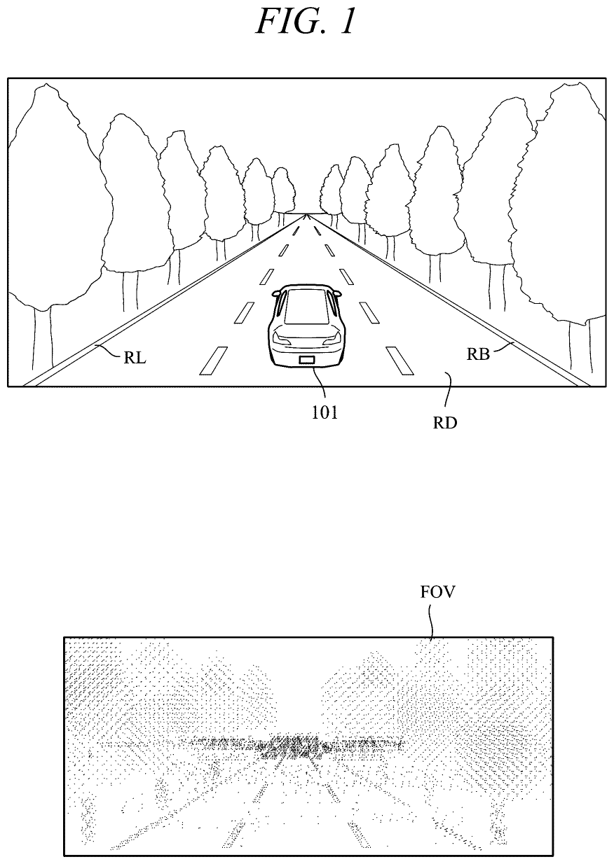

FIG. 1A is a diagram showing how a subject vehicle 101, which is a self-driving vehicle, drives on a road RD. FIG. 1B is a schematic diagram showing an example of detection data obtained by a LiDAR mounted on the subject vehicle 101 and directed in a traveling direction of the subject vehicle 101. A measurement point (which may also be referred to as a detection point) of the LiDAR is point information on what point an irradiated laser is reflected (scattered) back at on a surface of an object. The point information includes a distance from a laser source to the point, an intensity of the laser reflected (scattered) back, and a relative velocity between the laser source and the point.

Data including a plurality of detection points as shown in FIG. 1B will be referred to as point cloud data. FIG. 1B shows point cloud data based on detection points on surfaces of objects included in the field of view (hereinafter referred to as FOV) of the LiDAR among the objects in FIG. 1A. The FOV may be, for example, 120 deg in a horizontal direction (which may be referred to as a road width direction) and 25 deg in a vertical direction (which may be referred to as an up-down direction) of the subject vehicle 101. The value of the FOV may be appropriately changed, based on the specification of the external environment recognition device. The subject vehicle 101 recognizes an external environment situation around the vehicle, more specifically, a road structure, an object, and the like around the vehicle, based on the point cloud data as shown in FIG. 1B, and generates a target path based on the recognition result.

As a method for sufficiently recognizing the external environment situation around the vehicle, it may be considered to increase the number of irradiation points of electromagnetic waves irradiated from the in-vehicle detection apparatus such as a LiDAR (in other words, to increase the density of irradiation points of electromagnetic waves so as to increase the number of detection points constituting point cloud data). On the other hand, in a case where the number of irradiation points of electromagnetic waves is increased (the number of detection points is increased), there is a possibility that a processing load for controlling the in-vehicle detection apparatus increases, an amount of detection data (point cloud data) obtained by the in-vehicle detection apparatus increases, resulting in an increase in processing load for the point cloud data. In particular, in a situation where there are many objects on the road or beside the road, the amount of point cloud data further increases.

Therefore, in consideration of the above points, in the embodiment, the external environment recognition device is configured as follows.

### Overview

An external environment recognition device including a LiDAR according to the embodiment intermittently irradiates irradiation light as an example of an electromagnetic wave in a traveling direction of a subject vehicle 101 from the LiDAR of the subject vehicle 101 that drives on a road RD, and acquires point cloud data at different positions on the road RD in a discrete manner. The irradiation range of the irradiation light irradiated from the LiDAR is set such that a blank section of data does not occur in the traveling direction on the road RD in point cloud data of a previous frame that has been acquired by the LiDAR by previous irradiation and point cloud data for the next frame to be acquired by the LiDAR by current irradiation.

By setting the detection point density in the irradiation range, for example, to be higher for a road surface far from the subject vehicle 101 and to be lower for a road surface closer to the subject vehicle 101, the total number of detection points for use in recognition processing is reduced, as compared with that in a case where the detection point density is set to be high for all road surfaces in the irradiation range. By doing so, it is possible to reduce the number of detection points for use in recognition processing without deteriorating accuracy in recognizing a position (a distance from the subject vehicle 101) or a size of an object or the like recognized based on the point cloud data.

Such an external environment recognition device will be described in more detail.

### Configuration of Vehicle Control Device

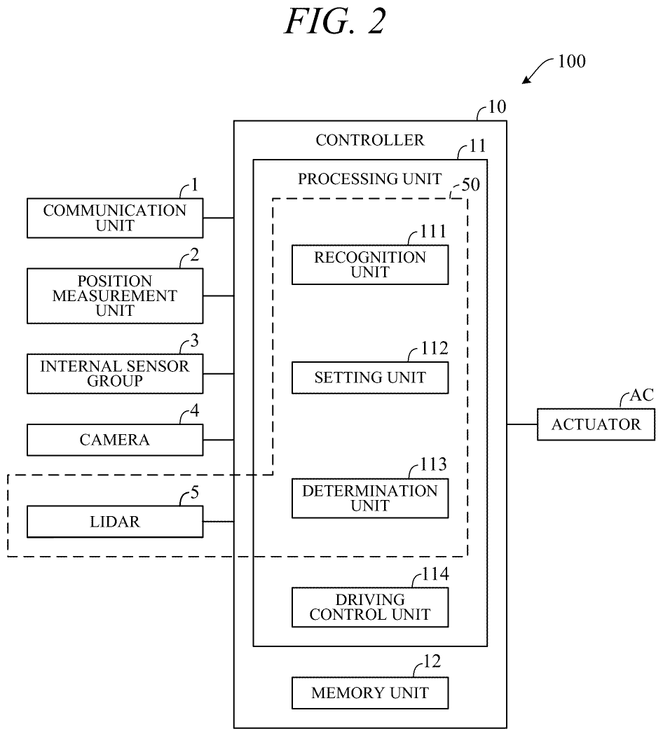

FIG. 2 is a block diagram illustrating a configuration of a main part of a vehicle control device 100 including an external environment recognition device. The vehicle control device 100 includes a controller 10, a communication unit 1, a position measurement unit 2, an internal sensor group 3, a camera 4, a LiDAR 5, and a driving actuator AC. In addition, the vehicle control device 100 includes an external environment recognition device 50, which constitutes a part of the vehicle control device 100. The external environment recognition device 50 recognizes an external environment situation around the vehicle, based on detection data of the in-vehicle detection apparatus such as the camera 4 or the LiDAR 5.

The communication unit 1 communicates with various servers (not illustrated) through a network including a wireless communication network represented by the Internet network, a mobile phone network, or the like, and acquires map information, driving history information, traffic information, and the like from the servers periodically or at a certain timing. The network includes not only a public wireless communication network but also a closed communication network provided for each predetermined management area, for example, a wireless LAN, Wi-Fi (registered trademark), Bluetooth (registered trademark), or the like. The acquired map information is output to a memory unit 12, and the map information is updated. The position measurement unit (GNSS unit) 2 includes a position measurement sensor that receives a position measurement signal transmitted from a position measurement satellite. The position measurement satellite is an artificial satellite such as a GPS satellite or a quasi-zenith satellite. By using the position measurement information received by the position measurement sensor, the position measurement unit 2 measures a current position (latitude, longitude, and altitude) of the subject vehicle 101.

The internal sensor group 3 is a general term for a plurality of sensors (internal sensors) that detect a driving state of the subject vehicle 101. For example, the internal sensor group 3 includes a vehicle speed sensor that detects a vehicle speed (a driving speed) of the subject vehicle 101, an acceleration sensor that detects an acceleration in a front-rear direction and an acceleration (lateral acceleration) in a left-right direction of the subject vehicle 101, a rotation speed sensor that detects a rotation speed of the driving power source, a yaw rate sensor that detects a rotation angular speed about a vertical axis at the center of gravity of the subject vehicle 101, and the like. The internal sensor group 3 also includes a sensor that detects a driver's driving operation in the manual drive mode, for example, an operation of an accelerator pedal, an operation of a brake pedal, or an operation of a steering wheel.

The camera 4 includes an imaging element such as a CCD or a CMOS, and captures images of the surroundings (forward, rearward, and sideward) of the subject vehicle 101. The LiDAR 5 receives scattered light with respect to the irradiation light, and measures a distance from the subject vehicle 101 to a surrounding object, a position and shape of the object, and the like.

The actuator AC is a driving actuator for controlling the driving of the subject vehicle 101. In a case where the driving power source is an engine, the actuator AC includes a throttle actuator that adjusts an opened degree (a throttle-opened degree) of a throttle valve of the engine. In a case where the driving power source is a driving motor, the driving motor is included in the actuator AC. The actuator AC also includes a braking actuator that operates a braking device of the subject vehicle 101, and a steering actuator that drives a steering device.

The controller 10 includes an electronic control unit (ECU). More specifically, the controller 10 includes a computer including a processing unit 11 such as a CPU (microprocessor), a memory unit 12 such as a ROM and a RAM, and other peripheral circuits (not illustrated) such as an I/O interface. Note that, although a plurality of ECUs having different functions such as an ECU for controlling the engine, an ECU for controlling the driving motor, and an ECU for the braking device can be individually provided, it is illustrated in FIG. 2 for the sake of convenience that the controller 10 is shown as a set of these ECUs.

The memory unit 12 can store highly precise detailed map information (referred to as high-precision map information). The high-precision map information includes information on positions of roads, information on shapes (curvatures or the like) of roads, information on gradients of roads, information on positions of intersections and branch points, information on the number of traffic lanes (driving lanes), information of widths of traffic lanes and positions of traffic lanes (information on center positions of traffic lanes or boundary lines between traffic lane positions), information on positions of landmarks (traffic lights, traffic signs, buildings, and the like) as marks on a map, and information on profiles of road surfaces such as irregularities of road surfaces. In addition to two-dimensional map information to be described below, the memory unit 12 can also store programs for various types of control, information on thresholds or the like for use in the programs, and information on settings for the in-vehicle detection apparatus such as the LiDAR 5 (including steering information of irradiation light to be described below).

Note that highly precise detailed map information is not necessarily required in the embodiment, and the detailed map information may not be stored in the memory unit 12.

The processing unit 11 includes a recognition unit 111, a setting unit 112, a determination unit 113, and a driving control unit 114, as functional components. Note that, as illustrated in FIG. 2, the recognition unit 111, the setting unit 112, and the determination unit 113 are included in the external environment recognition device 50. As described above, the external environment recognition device 50 recognizes an external environment situation around the vehicle based on the detection data of the in-vehicle detection apparatus such as the camera 4 or the LiDAR 5. The recognition unit 111, the setting unit 112, and the determination unit 113 included in the external environment recognition device 50 will be described in detail below.

In the self-drive mode, the driving control unit 114 generates a target path based on the external environment situation around the vehicle that has been recognized by the external environment recognition device 50, and controls the actuator AC so that the subject vehicle 101 drives along the target path. Note that in the manual drive mode, the driving control unit 114 controls the actuator AC according to a driving command (a steering operation or the like) from the driver that has been acquired by the internal sensor group 3.

The LiDAR 5 will be further described.

### Detection Region

The LiDAR 5 is attached to be directed forward of the subject vehicle 101 so that a region to be observed during driving is included in the FOV. Since the LiDAR 5 receives light (hereinafter referred to as return light) scattered by a three-dimensional object or the like irradiated with irradiation light, the FOV of the LiDAR 5 corresponds to the irradiation range and the detection region of the irradiation light. That is, irradiation points in the irradiation range correspond to detection points in the detection region.

In the embodiment, a road surface shape including an irregularity, a step, an undulation, or the like of a road surface, a three-dimensional object located on the road RD (equipment related to the road RD (a traffic light, a traffic sign, a groove, a wall, a fence, a guardrail, or the like)), an object on the road RD (including another vehicle or an obstacle on the road surface), or a division line provided on the road surface will be referred to as a three-dimensional object or the like. The division line includes a white line (including a line of a different color such as yellow), a curbstone line, a road stud, or the like, and may be referred to as a lane mark. In addition, a three-dimensional object or the like set in advance as a detection target will be referred to as a detection target.

### Irradiation Points of Irradiation Light

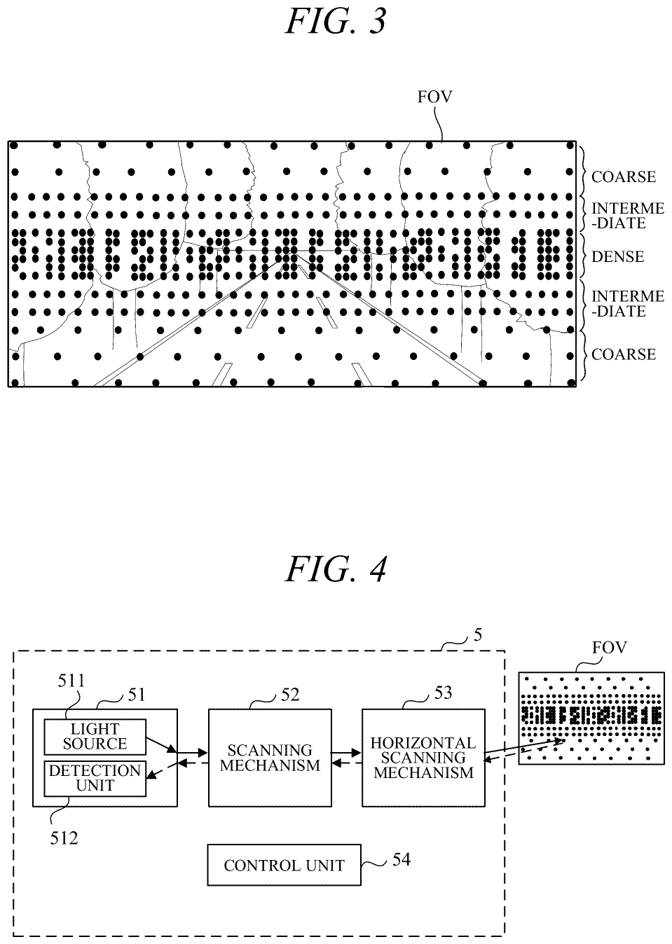

FIG. 3 is a schematic diagram for explaining irradiation points of irradiation light irradiated into the FOV by the LiDAR 5. The LiDAR 5 moves positions of the irradiation points by changing the light projection angle at which the irradiation light is projected in the vertical direction and in the horizontal direction. In the embodiment, the amount of change in light projection angle corresponding to a minimum value of movement intervals between the irradiation points will be referred to as an angular resolution.

In three-dimensional coordinates including an x axis, a y axis, and a z axis, a driving direction of the subject vehicle 101 corresponds to an x-axis plus direction, a left side in a horizontal direction of the subject vehicle 101 corresponds to a y-axis plus direction, and an upper side in a vertical direction of the subject vehicle 101 corresponds to a z-axis plus direction. In this case, an x-axis component of the position of the detection point will be referred to as a depth distance X, a y-axis component of the position of the detection point will be referred to as a horizontal distance Y, and a z-axis component of the position of the detection point will be referred to as a height Z.

In general, the larger the size of the detection target, and the shorter the depth distance X from the subject vehicle 101 to the detection target (in other words, the detection target is close to the subject vehicle 101), the larger the viewing angle with respect to the detection target. Therefore, even if the angular resolution of the LiDAR 5 is set to be low to some extent, the detection target can be detected. Conversely, the smaller the size of the detection target, and the longer the depth distance X (in other words, the detection target is far from the subject vehicle 101), the smaller the viewing angle with respect to the detection target. Therefore, unless the angular resolution of the LiDAR 5 is set to be high to some extent, it is difficult to detect the detection target. Therefore, the external environment recognition device 50 lowers the angular resolution of the LiDAR 5 (increases the numerical value) as the size of the detection target is larger and the depth distance X is shorter, and raises the angular resolution of the LiDAR 5 (decreases the numerical value) as the size of the detection target is smaller and the depth distance X is longer.

By raising the vertical angular resolution, the interval between the irradiation points in the vertical direction in the FOV decreases, the interval between the irradiation points becomes dense, and the number of irradiation points increases.

Conversely, by lowering the vertical angular resolution, the interval between the irradiation points in the vertical direction in the FOV increases, the interval between the irradiation points becomes coarse, and the number of irradiation points decreases.

The same applies to the horizontal angular resolution.

In FIG. 3, “dense” indicates, for example, an interval in the vertical direction between the irradiation points (detection points) corresponding to an angular resolution of 0.05 deg. “Intermediate” indicates, for example, an interval in the vertical direction between the irradiation points (detection points) corresponding to an angular resolution of 0.1 deg. “Coarse” indicates, for example, an interval in the vertical direction between the irradiation points (detection points) corresponding to an angular resolution of 0.2 deg.

Although it is illustrated in FIG. 3 as an example that the angular resolution is switched between three stages, the angular resolution may be appropriately switched between two or four stages, not limited to the three stages.

For example, the external environment recognition device 50 determines a required angular resolution based on the minimum size (e.g., 15 cm) of the detection target specified in advance and the required depth distance (e.g., 100 m). The required depth distance corresponds to a braking distance of the subject vehicle 101 that varies depending on the vehicle speed. In the embodiment, a value obtained by adding a predetermined margin to the braking distance will be referred to as the required depth distance, on the basis of the idea that the road surface situation on the road in the traveling direction of the subject vehicle 101 that is driving should be detected earlier than at least the braking distance. The vehicle speed of the subject vehicle 101 is detected by software processing such as SLAM using sensor data of the vehicle speed sensor of the internal sensor group 3, the LiDAR 5, and the like. The relationship between the vehicle speed and the required depth distance is stored in advance in the memory unit 12. When obtaining the detection speed from the vehicle speed sensor, the external environment recognition device 50 obtains a required depth distance corresponding to the vehicle speed, referring to the memory unit 12.

When the subject vehicle 101 is driving, for example, in the self-drive mode, the external environment recognition device 50 sets irradiation points between which an interval is different (in other words, irradiation points between which a density is different) for each region in the FOV, and controls the LiDAR 5 to sequentially irradiate these irradiation points with irradiation light. Thus, the irradiation light from the LiDAR 5 is irradiated toward the set irradiation point (detection point).

The external environment recognition device 50 stores information indicating the position of the set irradiation point (which may be referred to as steering information of the irradiation light) in the memory unit 12 in association with position information indicating the driving position of the subject vehicle 101 during driving.

For example, the angular resolution required to detect a detection target of 15 cm 100 m ahead of the subject vehicle 101 that is driving at a vehicle speed of 100 km/h is approximately 0.05 deg. When a detection target having a size smaller than 15 cm is detected, or when a detection target of 15 cm is detected at a depth distance X longer than 100 m, it is necessary to decrease the interval between irradiation points in the FOV by further raising the angular resolution.

Conversely, when a detection target of a size larger than 15 cm is detected, or then a detection target of 15 cm is detected at a depth distance X shorter than 100 m, the interval between the irradiation points in the FOV may be increased by further lowering the angular resolution.

Note that the number of actual irradiation points in the FOV is much larger than the number of black circles illustrated in FIG. 3. For example, when the FOV of the LiDAR 5 is 120 deg in the horizontal direction, a maximum of 1200 black circles 20 corresponding to irradiation points (detection points) in the horizontal direction are arranged in a case where the angular resolution is set to 0.1 deg in the entire region in the horizontal direction. Similarly, when the FOV is 25 deg in the vertical direction, a maximum of 500 black circles corresponding to irradiation points (detection points) in the vertical direction are arranged in a case where the angular resolution is set to 0.05 deg in the entire region in the vertical direction.

The external environment recognition device 50 reduces the total number of irradiation points (detection points), in other words, the total number of pieces of detection data for use in recognition processing, by controlling the interval between the detection points.

Specifically, in a region where the depth distance X is shorter than the required depth distance of the FOV, the viewing angle with respect to the detection target increases as described above, and thus, the number of irradiation points is reduced by increasing the interval between detection points in the vertical direction and the horizontal direction. In addition, in a region corresponding to the sky of the FOV, there is no detection target such as a road RD, and thus, the number of irradiation points is reduced by increasing the interval between irradiation points in the vertical direction and the horizontal direction. In this manner, in the LiDAR 5 as an in-vehicle detection apparatus, the necessity of setting the maximum angular resolution over the entire region in the horizontal direction and the vertical direction of the FOV (in other words, setting the maximum number of irradiation points by making the interval between irradiation points dense in the entire region of the FOV) is low, but the necessity of setting the maximum angular resolution in one certain region of the FOV is high.

The external environment recognition device 50 controls the steering of the irradiation direction of the irradiation light from the LiDAR 5 in each of the vertical direction and the horizontal direction whenever the irradiation light is scanned with respect to the FOV for one frame, acquires detection data of detection points indicated by the black circles in FIG. 3, and obtains point cloud data as shown in FIG. 1B.

### Steering Mechanism for Irradiation Light

The LiDAR 5 according to the embodiment includes a mechanical scanning mechanism as a horizontal scanning mechanism that changes the light projection angle in the horizontal direction and a solid-state scanning mechanism as a vertical scanning mechanism that changes the light projection angle in the vertical direction.

FIG. 4 is a schematic diagram exemplifying a configuration of the LiDAR 5. The LiDAR 5 includes, for example, a frequency modulated continuous wave (FMCW) type transceiver 51, a vertical scanning mechanism 52, a horizontal scanning mechanism 53, and a control unit 54. The control unit 54 includes a processing unit such as a processor and a memory such as a ROM and a RAM, and the processing unit executes a program stored in the memory to transmit and receive signals between the LiDAR 5 and the controller 10, and control (output control signals or the like) the transceiver 51, the vertical scanning mechanism 52, and the horizontal scanning mechanism 53.

The transceiver 51 includes a light source 511 and a detection unit 512. In the LiDAR 5, a solid arrow indicates a light transmission path, and a broken arrow indicates a light reception path.

### Vertical Scanning Mechanism

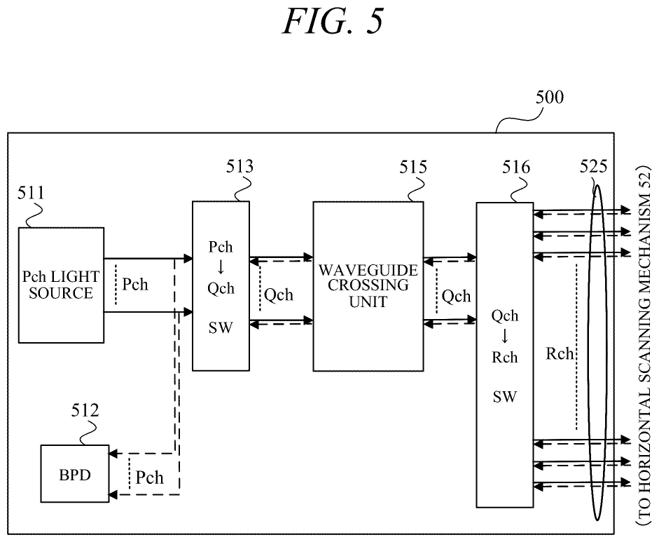

FIG. 5 is a block diagram for explaining the transceiver 51 and the vertical scanning mechanism 52 of the LiDAR 5 of FIG. 4 in more detail. The vertical scanning mechanism 500 including a transceiver includes a light source 511, a detection unit 512 that is a balanced photodiode (hereinafter referred to as a BPD), a first switch group 513, a waveguide crossing unit 515, a second switch group 516, and a projection lens 525. Hereinafter, the detection unit 512 will be referred to as the BPD 512.

The light source 511 includes Pch laser light sources having a plurality of (P) lasers that emit irradiation light to be transmitted to measurement points in the FOV. The P lasers can emit irradiation light at the same timing, or can emit irradiation light at individual timings. The light source 511 may include an amplifier that amplifies light emitted from the laser light source. In addition, the light source 511 may include a splitter that splits light emitted from the laser light source into a plurality of beams. The amplifier is useful for outputting a predetermined level of irradiation light to each channel when power of light of each laser from the light source 511 is small, or when power of light decreases by distributing the light to a plurality of channels.

The BPD 512 is an optical receiver that detects an interference signal between reference light and return light using two photodiodes having the same characteristics. In the embodiment, P sets of optical receivers are provided to correspond to the number of laser light sources of the light source 511. That is, Pch return beams can be simultaneously received.

The first switch group 513 is an optical switch group having Pch input terminals and Q(=P×n)ch output terminals. For example, P sets of 1×n switches, each selectively outputting an optical signal (hereinafter simply referred to as a beam) input from each input terminal to one of n output destinations, are provided. As a result, Pch beams input from the light source 511 are selectively output from Pch output terminals among the Qch output terminals. Note that n may be an odd number or an even number.

The first switch group 513 is configured by combining a plurality of optical switches, such as Mach-Zehnder interference type switches, as will be described below.

The waveguide crossing unit 515 has Qch waveguides formed on a silicon substrate. These waveguides are formed to allow beams from different lasers of the light source 511 to cross on the substrate. As a result, for example, when beams from the same laser are input to adjacent input terminals of the waveguide crossing unit 515, beams from different lasers are output from adjacent output terminals of the waveguide crossing unit 515.

The second switch group 516 is an optical switch group having Qch input terminals and R(=Q×s) ch output terminals. For example, Q sets of 1×s switches, each selectively outputting a beam input from each input terminal to one of s output destinations, are provided. As a result, Qch beams input from the waveguide crossing unit 515 are selectively output from Qch output terminals among the Rch output terminals. In the embodiment, since the number of light sources 511 is Pch, the number of beams output from the second switch group 516 at the same timing is Pch. Note that s may be an odd number or an even number.

Similarly to the first switch group 513, the second switch group 516 is configured by combining a plurality of optical switches, such as Mach-Zehnder interference type switches, as will be described below.

The projection lens 525 is disposed such that the R output terminals of the second switch group 516 are arranged on its focal plane. The projection lens 525 may be configured by, for example, an optical member acting as a lens in a direction in which at least R output terminals are arranged. R irradiation light beams output from the R output terminals are incident on different regions of the projection lens 525, and are irradiated onto different irradiation points in the FOV via the horizontal scanning mechanism 53.

### Overall Configuration of Transmission Light Branching Unit

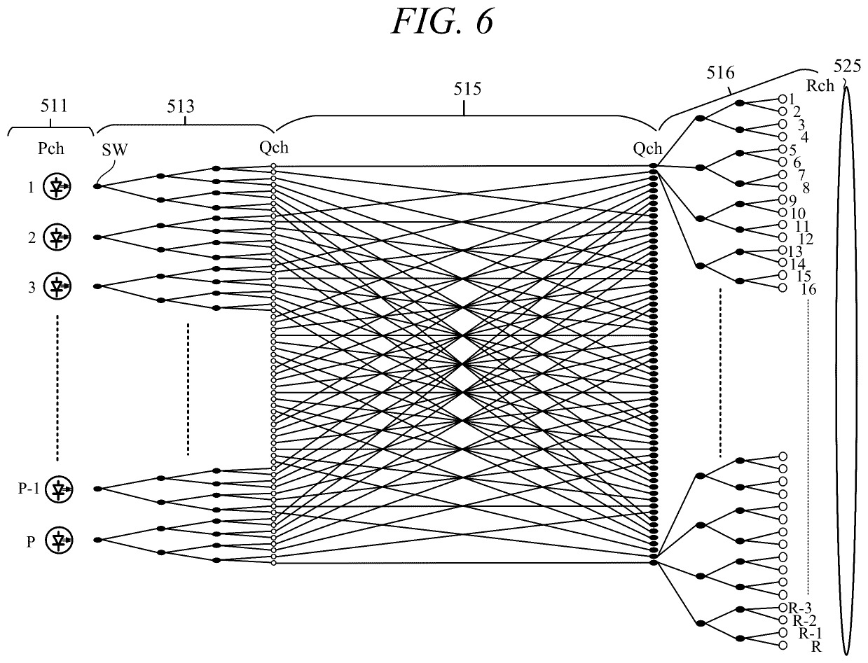

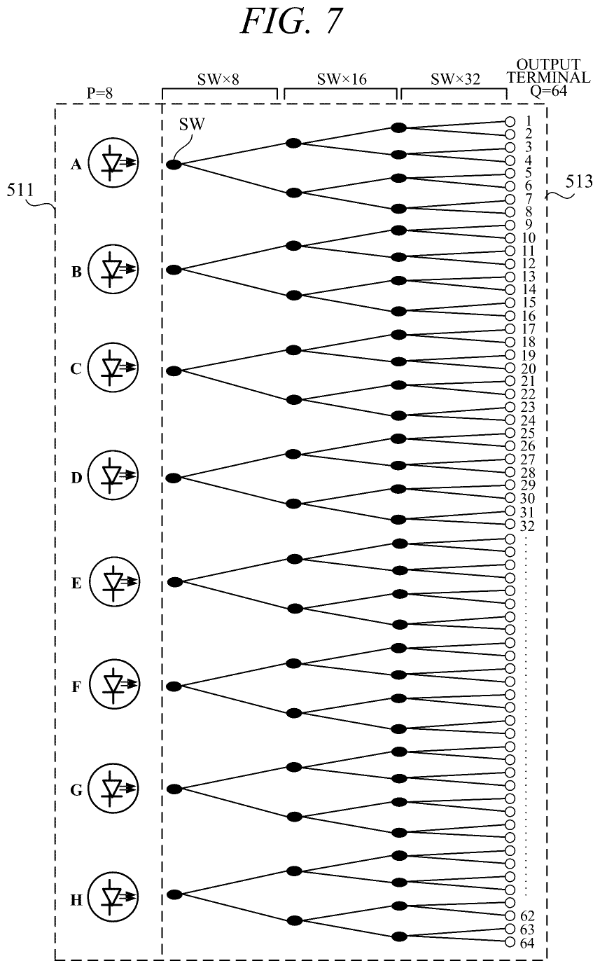

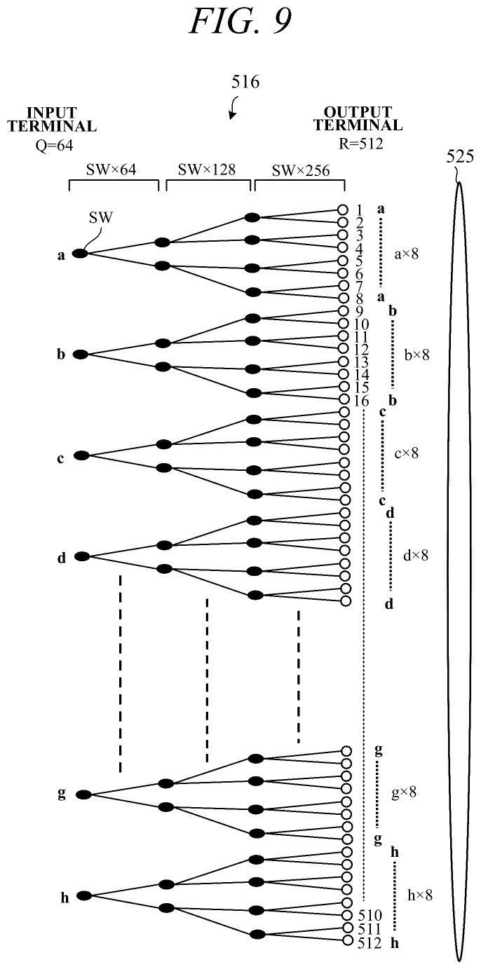

FIG. 6 is a schematic diagram illustrating an overall configuration of a transmission light branching unit extracted from the vertical scanning mechanism 500 exemplified in FIG. 5. In the embodiment, for example, the number of lasers of the light source 511 is set to P=8 ch. In addition, the number of input terminals of the first switch group 513 is P=8 ch, and the number of output terminals of the first switch group 513 is Q=64 ch. Further, the number of input terminals and the number of output terminals of the waveguide crossing unit 515 are set to Q=64 ch. Then, the number of input terminals of the second switch group 516 is Q=64 ch, and the number of output terminals of the second switch group 516 is R=512 ch. Note that black ellipses shown in FIG. 6 schematically represent 1×2 switches SW. Note that the same applies to black ellipses shown in FIGS. 7 and 9 to be described below.

As described above, the number of irradiation points required in a case where the FOV in the vertical direction is set to 25 deg and the vertical angular resolution is set to 0.05 deg is 500. In the embodiment, as an example, R=512 ch is set by adding a margin of +12 to 500.

The configuration of each unit will be described in more detail with reference to FIGS. 7 to 9.

FIG. 7 is a diagram for explaining the light source 511 and the first switch group 513 in the diagram of the overall configuration of the transmission light branching unit exemplified in FIG. 6.

The light source 511 is a P=8 ch light source including a laser A, a laser B, a laser C, . . . , a laser G, and a laser H.

The first switch group 513 is configured by combining a plurality of 1×2 switches SW in a tree shape, each selectively outputting input light to one of the 2 ch output terminals. In the embodiment, (seven) 1×2 switches SW in three layers are combined for each of the eight lasers A to H. As a result, each of the beams (beams a to h) emitted from the lasers A to His selectively output from one of the 8 ch output terminals.

With the above-described configuration, the first switch group 513 selectively outputs the 8 ch beams input from the light source 511 from P(=8) output terminals among Q=64 (=8×8) output terminals.

Note that the eight 1×2 switches SW provided at the 8 ch input terminals of the first switch group 513 will be referred to as first-layer switches SW. 16 switches provided on the right side (which may also be referred to as the downstream side) of the first-layer switches SW will be referred to as second-layer switches SW. In addition, 32 switches provided on the right side (downstream side) of the second-layer switches SW will be referred to as third-layer switches SW.

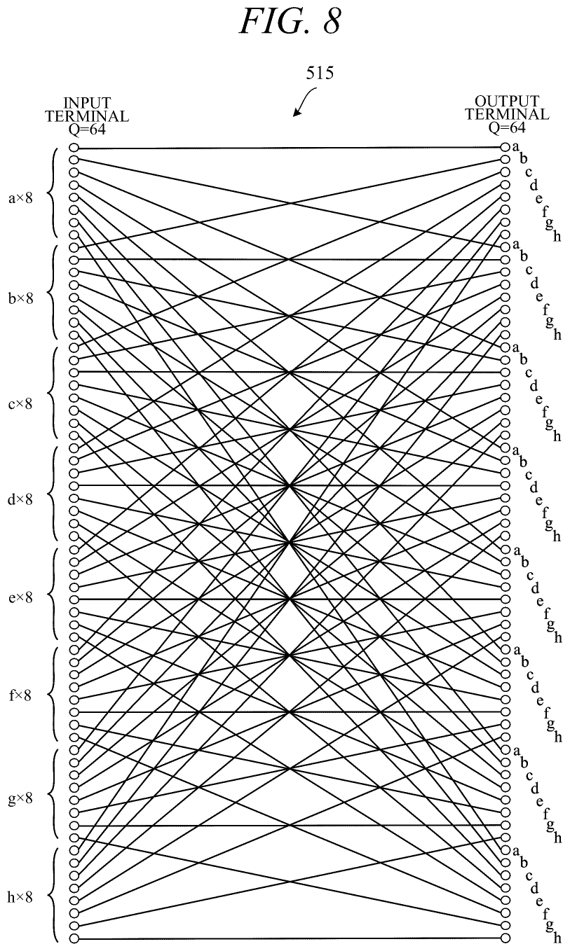

FIG. 8 is a diagram for explaining the waveguide crossing unit 515 in the diagram of the overall configuration exemplified in FIG. 6. For example, a total of 64(=8×8) terminals to which beams a to h from the lasers A to H are input for 8 ch are arranged at the 64 ch input terminals of the waveguide crossing unit 515, respectively.

The waveguide crossing unit 515 has Q=64 ch waveguides formed on a silicon substrate. In the embodiment, among the 64 ch waveguides, 62 ch waveguides excluding the uppermost 1 ch waveguide and the lowermost 1 ch waveguide in FIG. 8 are formed cross each other on the substrate. As a result, the order in which the beams are arranged at the input terminals of the waveguide crossing unit 515 is different from the order in which the beams are arranged at the output terminals of the waveguide crossing unit 515.

The positions where beams a are input are aligned for the first 8 ch input terminals, when counted from the uppermost terminal, among the 64 ch input terminals of the waveguide crossing unit 515. The positions where beams b are input are aligned for the next 8 ch input terminals. Similarly, the positions where beams are input from each of the lasers are arranged for every subsequent 8 ch input terminals in the order of beams c, beams d, beams e, beams f, beams g, and beams h.

The positions where a beam a, a beam b, a beam c, a beam d, a beam e, a beam f, a beam g, and a beam h are output are arranged in order by 1 ch for the first 8 ch output terminals, when counted from the uppermost terminal, among the 64 ch output terminals of the waveguide crossing unit 515. For the next 8 ch output terminals, the positions where a beam a, a beam b, a beam c, a beam d, a beam e, a beam f, a beam g, and a beam h are output are arranged in order by 1 ch.

Similarly, the positions where a beam a, a beam b, a beam c, a beam d, a beam e, a beam f, a beam g, and a beam h are output are arranged in order by 1 ch for every subsequent 8 ch output terminals. With this configuration, the output positions of the beams from each of the lasers are arranged repeatedly eight times in the order from the beam a to the beam h.

FIG. 9 is a diagram for explaining the second switch group 516 and the projection lens 525 in the diagram of the overall configuration exemplified in FIG. 6. The second switch group 516 according to the embodiment substantially includes 1×s(=8) switches by combining (seven) 1×2 switches SW in three layers in a tree shape for each of the 64 ch input terminals. That is, a beam input to each of the 64 ch input terminals is selectively output from one of the corresponding 8 ch output terminals.

Among the 1×2 switches SW in the three layers provided at the 64 ch input terminals, 64 switches provided on the left side (which may also be referred to as the upstream side) in FIG. 9 will be referred to as fourth-layer switches SW. 128 switches provided on the right side (which may also be referred to as the downstream side) of the fourth-layer switches SW will be referred to as fifth-layer switches SW. In addition, 256 switches provided on the right side (downstream side) of the fifth-layer switches SW will be referred to as sixth-layer switches SW.

With the above-described configuration, the second switch group 516 having R(=512)ch output terminals is configured such that a beam input to each of the Q(=64)ch input terminals is selectively output from one of the corresponding 8 ch output terminals.

As described above, R irradiation light beams output from the R output terminals are incident on different regions of the projection lens 525. Then, the R beams are irradiated to different irradiation points in the FOV via the horizontal scanning mechanism 53.

Note that, as is clear from FIG. 9, beams a, beams b, beams c, beams d, beams e, beams f, beams g, and beams h are incident on different regions of the projection lens 525. That is, the laser A, the laser B, the laser C, the laser D, the laser E, the laser F, the laser G, and the laser H are irradiated to different irradiation points in the FOV. In other words, the laser A, the laser B, the laser C, the laser D, the laser E, the laser F, the laser G, and the laser H are different in irradiation region in the FOV.

As described above, the vertical scanning mechanism 500 switches a position (which may also be referred to as a region) where an irradiation light beam emitted from an output terminal of the second switch group 516 is incident on the projection lens 525, by controlling the switching between the lasers emitted from the light source 511 and the switching between the optical switches of the first switch group 513 and the second switch group 516.

R irradiation light beams corresponding to R irradiation points arranged in the vertical direction in the FOV can be emitted from the R(=512) ch output terminals of the second switch group 516. In the embodiment, since the number of lasers that can be emitted from the light source 511 at the same timing is 8 ch, the number of irradiation light beams that can be emitted simultaneously is 8. While switching the optical switches of the first switch group 513 and the second switch group 516, the LiDAR 5 shifts the laser emission timing in time series to sequentially emit the necessary one of the 8 ch lasers, thereby scanning the irradiation light in the vertical direction. As an example, by emitting 8 ch lasers in multiple separate bursts as necessary, irradiation light beams can be emitted to the irradiation points arranged in the vertical direction in the FOV as exemplified by black circles in FIG. 3. That is, it is possible to intelligently change the light emission location according to the required irradiation point.

As will be described below, the vertical angular resolution determined by the determination unit 113 corresponds to an interval in the vertical direction between detection points when three-dimensional point cloud data for the next frame is acquired. As an example, by referring to table data (steering information of irradiation light) indicating a relationship between the irradiation points (corresponding to the black circles in FIG. 3) in the FOV and the switching states (the optical path-selected states) between the optical switches of the first switch group 513 and the second switch group 516 stored in advance in the memory unit 12, the LiDAR 5 determines a laser to be emitted and switching states between the optical switches of the first switch group 513 and the second switch group 516.

As in the embodiment, adopting a solid-state scanning mechanism as the vertical scanning mechanism 52 makes it possible to increase the affinity with processing of increasing the output of the irradiation light in a predetermined range designated in the field of view as a region of interest (ROI) to extend the detection distance in the predetermined range, or to increase the angular resolution in the predetermined range, thereby increasing performance in detecting an object or the like.

### Horizontal Scanning Mechanism

In FIG. 4, as an example, the horizontal scanning mechanism 53 controls a direction of an irradiation light beam by reflecting the irradiation light beam using a polygon mirror rotated by a motor.

The horizontal viewing angle required for the LiDAR 5 as an in-vehicle detection apparatus is, for example, 120 deg. Then, it is required to scan the range of 120 deg with an angular resolution of 0.1 deg and at a constant predetermined speed. Therefore, in the embodiment, a mechanical scanning mechanism capable of stably scanning a wider range of deflection angles than the solid-state scanning mechanism is adopted as the horizontal scanning mechanism 53, and irradiation light is changed in the horizontal direction.

As a specific example of the number of irradiation points in a case where scanning is performed at a viewing angle of 120 deg with an angular resolution of 0.1deg, irradiation light is irradiated to 1200 irradiation points in the horizontal direction, and scattered light from each of the irradiation points is received.

As will be described below, the horizontal angular resolution determined by the determination unit 113 corresponds to an interval in the horizontal direction between detection points when three-dimensional point cloud data for the next frame is acquired. As an example, by referring to table data (steering information of irradiation light) indicating a relationship between the irradiation points (corresponding to the black circles in FIG. 3) in the FOV and the position of the polygon mirror stored in advance in the memory unit 12, the LiDAR 5 determines a position of the polygon mirror at the time of emitting a laser.

### Configuration of External Environment Recognition Device

The external environment recognition device 50 will be described in detail.

As described above with reference to FIG. 2, the external environment recognition device 50 includes a recognition unit 111, a setting unit 112, a determination unit 113, and a LiDAR 5.

### Recognition Unit

The recognition unit 111 generates three-dimensional point cloud data using time-series detection data detected in the FOV of the LiDAR 5.

In addition, the recognition unit 111 recognizes a road structure in a traveling direction of a road RD on which the subject vehicle 101 drives, and a detection target on the road RD in the traveling direction based on the detection data measured by the LiDAR 5. The road structure refers to, for example, a straight road, a curved road, a branch road, a tunnel entrance, or the like.

Further, the recognition unit 111 detects a division line, for example, by performing luminance filtering processing or the like on data indicating a flat road surface. In this case, when a height of a road surface on which the luminance exceeds a predetermined threshold is substantially the same as a height of a road surface on which the luminance does not exceed the predetermined threshold, the recognition unit 111 may determine that it is a division line.

### Recognition of Road Structure

An example in which a road structure is recognized by the recognition unit 111 will be described. The recognition unit 111 recognizes, as a boundary line RL or RB of the road RD (FIG. 1A), a curbstone, a wall, a groove, a guardrail, or a division line on the road RD on a forward side, which is the traveling direction, included in the generated point cloud data. Then, the recognition unit 111 recognizes a road structure in the traveling direction indicated by the boundary line RL or RB. As described above, the division line includes a white line (including a line of a different color), a curbstone line, a road stud, or the like, and a traveling lane of the road RD is defined by a marking based on this division line. In the embodiment, the boundary line RL or RB defined by the marking on the road RD will be referred to as a division line.

The recognition unit 111 recognizes a region interposed between the boundary lines RL and RB, as a region corresponding to the road RD. Note that the method for recognizing the road RD is not limited thereto, and the road RD may be recognized by another method.

In addition, the recognition unit 111 classifies the generated point cloud data into point cloud data indicating flat road surfaces and point cloud data indicating three-dimensional objects or the like. For example, among the three-dimensional objects or the like on the road in the traveling direction included in the point cloud data, road surface shapes such as irregularities, steps, and undulations of which the sizes exceed a predetermined value (e.g., 15 cm) and objects of which the longitudinal and transverse sizes exceed the predetermined value are recognized as detection targets. 15 cm is an example of a size of a detection target, and the size of the detection target may be appropriately changed.

### Setting Unit

The setting unit 112 sets a vertical light projection angle φ of irradiation light to the LiDAR 5. In a case where the FOV of the LiDAR 5 is 25 deg in the vertical direction as described above, the vertical light projection angle φ is set in a range of 0 to 25 deg at an interval of 0.05 deg. Similarly, the setting unit 112 sets a horizontal light projection angle θ of irradiation light to the LiDAR 5. In a case where the FOV of the LiDAR 5 is 120 deg in the horizontal direction as described above, the horizontal light projection angle θ is set in a range of 0 to 120 deg at an interval of 0.1 deg.

The setting unit 112 sets irradiation points (corresponding to the black circles in FIG. 3) in the FOV to the LiDAR 5 based on the angular resolution determined by the determination unit 113 to be described below. As an example, the intervals in the vertical direction and in the horizontal direction between irradiation points (detection points) arranged in the FOV correspond to the angular resolutions in the vertical direction and the horizontal direction, respectively.

### Determination Unit

The determination unit 113 determines an angular resolution to be set by the setting unit 112. Here, an angle of irradiation light with respect to the horizontal direction (e.g., an angle downward from the horizontal direction will be indicated as a minus angle, and an angle upward from the horizontal direction will be indicated as a plus angle) will be referred to as a vertical light projection angle α (which may also be referred to as a vertical angle). First, the determination unit 113 calculates a vertical light projection angle a at each depth distance X and a distance DL to a road surface point at each depth distance X. Specifically, the depth distance X is calculated, based on the distance DL from the LiDAR 5 to the road surface point measured by the LiDAR 5 and the light projection angle α set to the LiDAR 5 at the time of measurement. The determination unit 113 calculates a relationship between the calculated depth distance X and the vertical angle. In addition, the determination unit 113 calculates a relationship between the depth distance X and the distance DL. Furthermore, the determination unit 113 calculates a relationship between the depth distance X and the vertical angular resolution, based on the size of the detection target and the depth distance X. In this manner, the vertical angular resolution is calculated based on the size of the detection target and the distance DL, and the relationship between the depth distance X and the vertical angular resolution is calculated based on the distance DL and the depth distance X.

Next, the determination unit 113 determines a vertical angular resolution required for recognizing a detection target having the above-described size. For example, for the depth distance X at which the vertical angular resolution is smaller than 0.1 deg in FIG. 3, 0.05 deg, which is smaller than 0.1 deg, is determined as the required angular resolution. In addition, for the depth distance X at which the vertical angular resolution is equal to or larger than 0.1 deg and smaller than 0.2 deg, 0.1 deg, which is smaller than 0.2 deg, is determined as the required angular resolution. Similarly, for the depth distance X at which the vertical angular resolution is equal to or larger than 0.2 deg and smaller than 0.3 deg and the depth distance X at which the vertical angular resolution is equal to or larger than 0.3 deg and smaller than 0.4 deg, 0.2 deg and 0.3 deg, which are smaller than 0.3 deg and 0.4 deg, respectively, are determined as the required angular resolutions.

The determined required vertical angular resolution can be reflected as an interval in the vertical direction between detection points when three-dimensional point cloud data for the next frame is acquired.

In addition, the determination unit 113 may determine a horizontal angular resolution required for recognizing a detection target in accordance with the size of the detection target and the depth distance X. The required horizontal angular resolution can also be reflected as an interval in the horizontal direction between detection points when three-dimensional point cloud data for the next frame is acquired.

Note that the required horizontal angular resolution may be matched with the required vertical angular resolution that has been determined previously. In other words, on the same horizontal line with the detection point at which the required vertical angular resolution has been determined to be 0.05 deg, the required horizontal angular resolution is determined to be 0.05 deg. Similarly, on the same horizontal line with the detection point at which the required vertical angular resolution has been determined to be 0.1 deg, the required horizontal angular resolution is determined to be 0.1 deg. Furthermore, for other required angular resolutions, on the same horizontal line with the detection point at which the required vertical angular resolution has been determined, the required horizontal angular resolution is determined to be the same value as the required vertical angular resolution.

### Generation of Position Data

The external environment recognition device 50 is capable of generating continuous position data by mapping data indicating positions of detection targets detected based on time-series point cloud data measured in real time by the LiDAR 5, for example, on a two-dimensional map of an x-y plane. In an x-y space, information indicating a height Z is omitted, and information on a depth distance X and a horizontal distance Y remains.

The recognition unit 111 acquires the information on a position of a three-dimensional object or the like on the two-dimensional map stored in the memory unit 12, and calculates a relative position of the three-dimensional object or the like converted into coordinates with the position of the subject vehicle 101 as the center, from a moving speed and a moving direction (e.g., an azimuth angle) of the subject vehicle 101. Whenever point cloud data is acquired by the LiDAR 5 by measurement, the recognition unit 111 converts a relative position of a three-dimensional object or the like based on the acquired point cloud data into coordinates with the position of the subject vehicle 101 as the center, and records the coordinates of the relative position of a three-dimensional object or the like on a two-dimensional map.

### Description of Flowchart

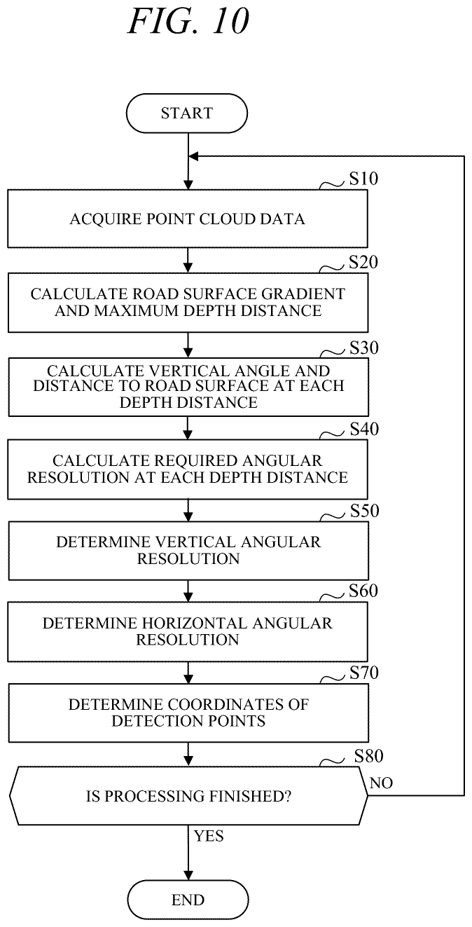

FIG. 10 is a flowchart showing an example of processing executed by the processing unit 11 of the controller 10 in FIG. 2 in accordance with a predetermined program. The processing shown in the flowchart of FIG. 10 is repeated, for example, every predetermined cycle while the subject vehicle 101 is driving in the self-drive mode.

First, in step S10, the processing unit 11 causes the LiDAR 5 to acquire three-dimensional point cloud data, and proceeds to step S20.

In step S20, the processing unit 11 calculates a road surface gradient in the traveling direction of a road RD and a maximum depth distance based on the point cloud data acquired by the LiDAR 5.

For example, the processing unit 11 obtains point cloud data indicating a flat road surface by detecting and separating data indicating a three-dimensional object or the like on the road RD from the point cloud data indicating detection points determined by the determination unit 113. The three-dimensional object or the like includes another vehicle such as a two-wheeled vehicle that is driving, as well as an obstacle on a road, and curbstones, walls, grooves, guardrails, or the like provided at the left and right ends of the road RD.

Next, the processing unit 11 calculates a road surface gradient of the road RD based on the point cloud data indicating the road surface. Since the road surface gradient calculation processing is known, detailed description thereof will be omitted. Further, the processing unit 11 calculates a maximum depth distance, and proceeds to step S30. The maximum depth distance may be the farthest depth distance that can be detected by the LiDAR 5.

In step S30, the processing unit 11 calculates a vertical light projection angle and a distance DL to the road surface point at each depth distance X, and proceeds to step S40. The relationship between the light projection angle a and the depth distance X may be stored in the memory unit 12 in advance.

In step S40, the processing unit 11 calculates a required angular resolution at each depth distance X, and proceeds to step S50. The required angular resolution is an angular resolution required for detecting a detection target having a size designated in advance. The relationship between the depth distance X and the angular resolution may be stored in the memory unit 12 in advance.

In step S50, the processing unit 11 causes the determination unit 113 to determine the vertical angular resolution to be a required angular resolution, and proceeds to step S60. The required vertical angular resolution determined here is reflected as an interval in the vertical direction between detection points when three-dimensional point cloud data for the next frame is acquired.

In step S60, the determination unit 113 of the processing unit 11 determines the horizontal angular resolution to be a required angular resolution, and proceeds to step S70. The required horizontal angular resolution determined here is also reflected as an interval in the horizontal direction between detection points when three-dimensional point cloud data for the next frame is acquired.

In step S70, the processing unit 11 determines coordinates of detection points. More specifically, the processing unit 11 determines coordinates indicating the positions of the detection points as exemplified by the black circles in FIG. 3.

The control unit 54 reflects the positions of the detection points determined in step S70 as steering information of irradiation light emitted by the LiDAR 5 when three-dimensional point cloud data for the next frame is acquired.

In addition, the recognition unit 111 recognizes a three-dimensional object or the like in the traveling direction of the road RD on which the subject vehicle 101 drives, based on the detection data detected at the positions of the detection points determined in step S70.

Note that, whenever point cloud data is acquired in step S10, the processing unit 11 generates continuous position data in a two-dimensional manner by mapping a relative position of the three-dimensional object or the like based on the point cloud data on a two-dimensional map of an x-y plane. Then, the relative position of the three-dimensional object or the like based on the point cloud data can be converted into the coordinates with the position of the subject vehicle 101 as the center, and the coordinates of the relative position of the three-dimensional object or the like can be recorded on the two-dimensional map.

In step S80, the processing unit 11 determines whether to end the processing. When the subject vehicle 101 is continuously driving in the self-drive mode, the processing unit 11 makes a negative determination in step S80, returns to step S10, and repeats the above-described processing. By returning to step S10, the measurement of the three-dimensional object or the like based on the point cloud data is periodically and repeatedly performed while the subject vehicle 101 is driving. On the other hand, when the subject vehicle 101 has finished driving in the self-drive mode, the processing unit 11 makes an affirmative determination in step S80, and ends the processing of FIG. 10.

According to the embodiment described above, the following effects are obtained.
(1) A LiDAR 5 includes a vertical scanning mechanism 500 as a first scanning unit that scans and irradiates optical signals (beam a to beam h) in a vertical direction as a first direction, and a horizontal scanning mechanism 53 as a second scanning unit that scans and irradiates optical signals (beam a to beam h) in a horizontal direction as a second direction intersecting the vertical direction, and functions as an in-vehicle detection apparatus that detects an external environment situation by scanning and irradiating the optical signals (beam a to beam h) in the FOV.

The vertical scanning mechanism 500 as at least one of the first scanning unit and the second scanning unit includes: a first switch group 513 as a first optical branching unit that receives the optical signals (beam a, beam b, . . . ) from lasers A to H as a plurality of light sources, respectively, and selectively switches a destination to which each of the optical signals is output to one of the output destinations of a plurality of channels (8 ch); a waveguide crossing unit 515 that crosses at least some optical signals among the plurality of optical signals (beam a, beam b, . . . ) output from the first switch group 513; and a second switch group 516 as a second optical branching unit that receives the plurality of optical signals (beam a, beam b, . . . ) output from the waveguide crossing unit 515, and selectively switches a destination to which each of the optical signals is output to one of the output destinations of a plurality of channels (8 ch).

In particular, by including the waveguide crossing unit 515 that crosses the optical signals (beam a, beam b, . . . ) output from the first switch group 513, the vertical scanning mechanism 500 can output the optical signals (beam a, beam b, . . . ) after being crossed by the waveguide crossing unit 515. As a result, the optical signals (beam a, beam b, . . . ) output from the vertical scanning mechanism 500 can be made dense as compared with those in a case where the waveguide crossing unit 515 is not provided. More specifically, by switching the order in which the optical signals output from output terminals of the vertical scanning mechanism 500 are arranged, for example, the terminal from which the beam a is output and the terminal from which the beam b is output can be brought close to each other, or the positional relationship between the terminals from which the beam a and the beam b are output can be shifted.

If a multilayer optical switch such as an integrated optical switch is combined with a conventional technology (a configuration in which a plurality of demultiplexing elements are merely stacked), even though optical signals output from output terminals of the integrated optical switch can be made dense, the excessively large size of the integrated optical switch hinders a reduction in size of the LiDAR. Furthermore, the internal loss of the integrated optical switch reduces power of irradiation light, making it difficult to satisfy the requirements (in particular, small size and long-distance measurement) as the in-vehicle detection apparatus.

However, the LiDAR 5 according to the embodiment, which is not affected by the size of the integrated optical switch and the internal loss of the integrated optical switch, can realize size reduction and long-distance measurement as an in-vehicle detection apparatus.
(2) In the LiDAR 5 according to (1), the first switch group 513 includes first optical switches (for example, 1×2 switches SW in three layers each switching an optical path of the beam a among switches in first to third layers constituting the first switch group 513), each receiving an optical signal (beam a) from the laser A as a first light source and selectively outputting the optical signal (beam a) from one of output destinations of eight as a first predetermined number of channels, and second optical switches (for example, 1×2 switches SW in three layers each switching an optical path of the beam b among switches in first to third layers constituting the first switch group 513), each receiving an optical signal (beam b) from the laser B as a second light source and selectively outputting the optical signal (beam b) from one of output destinations of eight as a second predetermined number of channels, the waveguide crossing unit 515, each receiving an optical signal (beam b) output from each of the second optical switches among the optical signals output from the waveguide crossing unit 515 and selectively outputting the optical signal from one of output destinations of eight as a third predetermined number of channels.

With this configuration, the configurations (the number of channels) of switches constituting the optical path of the beam a and the optical path of the beam b are substantially equal, making it possible to suppress the deviation in loss between the optical paths.
(3) In the LiDAR 5 according to (2), the waveguide crossing unit 515 includes, for example, input terminals of a first predetermined number of (eight) channels to which optical signals (beams a) from the laser A are input and input terminals of a second predetermined number of (eight) channels to which optical signals (beams b) from the laser B are input as input terminals of a plurality of channels, and includes output terminals of a first predetermined number of (eight) channels which output optical signals (beams a) from the laser A and output terminals of a second predetermined number of (eight) channels which output optical signals (beams b) from the laser B as output terminals of a plurality of channels, and crosses the optical signals such that optical signals (beams a or lights b) input to channels that are adjacent to each other at the input terminals of the plurality of channels are output from channels that are not adjacent to each other at the output terminals of the plurality of channels.

With this configuration, for example, it is possible to easily bring the terminal from which the beam a is output and the terminal from which the beam b is output close to each other, or easily shift the positional relationship between the terminals from which the beam a and the beam b are output.
(4) In the LiDAR 5 according to (2) or (3), the waveguide crossing unit 515 is provided between the first and second optical switches and the third and fourth optical switches.

With this configuration, the number of intersections between waveguides can be reduced as compared with that in a case where the waveguide crossing unit 515 is provided on a side where the output terminals of the third and fourth optical switches are located. That is, the number of intersections can be reduced by crossing (8+8) optical signals rather than crossing optical signals corresponding to the number of output terminals ((8+8)×8) of the third and fourth optical switches, making it possible to reduce the area of the chip constituting the waveguide crossing unit 515, to facilitate chip design, and to reduce crosstalk and reflection.
(5) In the LiDAR 5 according to (4), an optical signal (beam a) from the laser A is projected to a first region (e.g., a region irradiated with a beam output from ch8 of the third optical switch) in a FOV, an optical signal (beam b) from the laser B is projected to a second region (e.g., a region irradiated with a beam output from ch9 of the fourth optical switch) in the FOV, and the first region and the second region can be projected to at the same light projection timing. Specifically, in the LiDAR 5 according to (4), the control unit 54 is configured to output control signals to the first optical switches and the third optical switches such that an optical signal (beam a) from the laser A is projected to the first region in the FOV, and output control signals to the second optical switches and the fourth optical switches such that an optical signal (beam b) from the laser B is projected to the second region in the FOV at the same light projection timing as the optical signal (beam a) projected to the first region.

With this configuration, the scanning time of the LiDAR 5 can be reduced as compared with that in a case where beams are projected to the first region and the second region at different timings.
(6) In the LiDAR 5 according to (5), the optical signal (beam a) from the laser A is further projected to a third region (e.g., a region irradiated with a beam output from ch7 of the third optical switch) in the FOV, the optical signal (beam b) from the laser B is further projected to a fourth region (e.g., a region irradiated with a beam output from ch11 of the fourth optical switch) in the FOV, and the third region and the fourth region can be projected to at the same light projection timing, while the first region and the third region can be projected to at different timings, and the second region and the fourth region can be projected to at different timings. Specifically, in the LiDAR 5 according to (5), the control unit 54 is configured to output control signals to the first optical switches and the third optical switches such that the optical signal (beam a) from the laser A is further projected to the third region in the FOV at a timing different from the timing at which the first region is projected to, and output control signals to the second optical switches and the fourth optical switches such that the optical signal (beam b) from the laser B is further projected to the fourth region in the FOV at a timing that is the same as the timing at which the optical signal (beam a) from the laser A is projected to the third region and that is different from the timing at which the optical signal (beam b) from the laser B is projected to the second region.

With this configuration, the number of lasers of the LiDAR 5 can be reduced as compared with that in a case where the regions to which the laser A and the laser B project beams correspond to the first region and the second region in a one-to-one manner.
(7) In the LiDAR 5 according to (6), the optical signal (beam a) from the laser A is further projected to a fifth region (e.g., a region irradiated with a beam output from ch4 of the third optical switch) in the FOV, the optical signal (beam b) from the laser B is further projected to a sixth region (e.g., a region irradiated with a beam output from ch16 of the fourth optical switch) in the FOV, and the fifth region and the sixth region can be projected to at the same light projection timing, while the first region, the third region, and the fifth region can be projected to at different timings, and the second region, the fourth region, and the sixth region can be projected to at different timings. Specifically, in the LiDAR 5 according to (6), the control unit 54 is configured to output control signals to the first optical switches and the third optical switches such that the optical signal (beam a) from the laser A is further projected to the third region in the FOV at a timing different from the timing at which the first region is projected to, and output control signals to the second optical switches and the fourth optical switches such that the optical signal (beam b) from the laser B is further projected to the sixth region in the FOV at a timing that is the same as the timing at which the optical signal (beam a) from the laser A is projected to the fifth region and that is different from the timing at which the optical signal (beam b) from the laser B is projected to the second region and the fourth region.

With this configuration, the number of lasers of the LiDAR 5 can be further reduced as compared with that in the configuration of (6) described above.

The above-described embodiment can be modified in various manners. Hereinafter, modifications will be described.

### First Modification

In the above-described embodiment, an example has been described in which the solid-state scanning mechanism is adopted only for the vertical scanning mechanism 500 that is one of the first scanning unit and the second scanning unit. Alternatively, a solid-state scanning mechanism may also be adopted for the horizontal scanning mechanism 53 as the second scanning unit, similarly to the vertical scanning mechanism 500.

Furthermore, a solid-state scanning mechanism may be adopted only for the horizontal scanning mechanism 53 that is one of the first scanning unit and the second scanning unit.

In a case where the solid-state scanning mechanism is adopted only for one of the first scanning unit and the second scanning unit, it is preferable to adopt the solid-state scanning mechanism as the vertical scanning mechanism 500 for the following reasons.

That is, this is because the LiDAR 5 as an in-vehicle detection apparatus is required to have a vertical viewing angle (25 deg in the above-described example) smaller than a horizontal viewing angle (120 deg in the above example), and the range in which the angular resolution of 0.05 deg, which is finer than 0.1 deg, is required within the region of the viewing angle of 25 deg is narrower (e.g., about 10 deg). Therefore, in a case where irradiation light having a high angular resolution is irradiated only to the region of 10 deg within the region of the viewing angle of 25 deg, the number of irradiation points in the vertical direction (corresponding to the number R of output terminals of the second switch group 516) can be made smaller than 512, which has been described above.

In addition, one of the reasons is that while irradiation light is controlled to be driven in the horizontal direction by the horizontal scanning mechanism 53, the scanning operation of the vertical scanning mechanism 500 can be stopped, and accordingly, the scanning speed in the vertical direction may be slower than the scanning speed in the horizontal direction.

For the above reasons, in a case where a solid-state scanning mechanism is adopted only for one of the first scanning unit and the second scanning unit, the solid-state scanning mechanism having excellent durability against vibration and impact as compared with a mechanical scanning mechanism is used as the vertical scanning mechanism 500.

### Second Modification

The number (512 in the vertical direction and 1200 in the horizontal direction) of irradiation points in the FOV of the LiDAR 5, the number P(=8) of lasers constituting the light source, the number (8+16+32=56) of optical switches constituting the first switch group 513, the number Q(=64) of output terminals of the first switch group 513, the number (7×64=448) of optical switches constituting the second switch group 516, and the number R(=512) of output terminals of the second switch group 516 are all examples, and may be appropriately changed. Another example will be described in the following third modification.

### Third Modification

In the above-described embodiment, a case where the number of channels (=first predetermined number) at the output terminals of the first optical switches, the number of channels (=second predetermined number) at the output terminals of the second optical switches, the number of channels (=third predetermined number) at the output terminals of the third and fourth optical switches, the number of third optical switches (=first predetermined number), and the number of fourth optical switches (=second predetermined number) are the same (=8) has been described.

In the third modification, a case where the first predetermined number, the second predetermined number, and the third predetermined number are not equal will be described. As an example, a case where the first predetermined number (e.g., 6) is different from the second predetermined number (e.g., 5), and the third predetermined number (e.g., 8) is larger than the first predetermined number and the second predetermined number will be described.

In the third modification, the number of irradiation points in the FOV of the LiDAR 5 is 504 in the vertical direction and 1200 in the horizontal direction, the number of lasers constituting the light source is P=12, the number of optical switches constituting the first switch group 513 is 12+24+15=51, the number of output terminals of the first switch group 513 is Q(=63), the number of optical switches constituting the second switch group 516 is 7×63=441, and the number of output terminals of the second switch group 516 is R(=504).

### Overall Configuration of Transmission Light Branching Unit

The configuration according to the third modification, where the number of lasers of the light source 511 is P=12 ch, will be described with reference to the schematic diagram of FIG. 6. In addition, the number of input terminals of the first switch group 513 is P=12 ch, and the number of output terminals of the first switch group 513 is Q=63 ch. Further, the number of input terminals and the number of output terminals of the waveguide crossing unit 515 are set to Q=63 ch. Then, the number of input terminals of the second switch group 516 is Q=63 ch, and the number of output terminals of the second switch group 516 is R=504 ch.

As described above, the number of irradiation points required in a case where the FOV in the vertical direction is set to 25 deg and the vertical angular resolution is set to 0.05deg is 500. In the third modification, R=504 ch is set by adding a margin of +4 to 500.

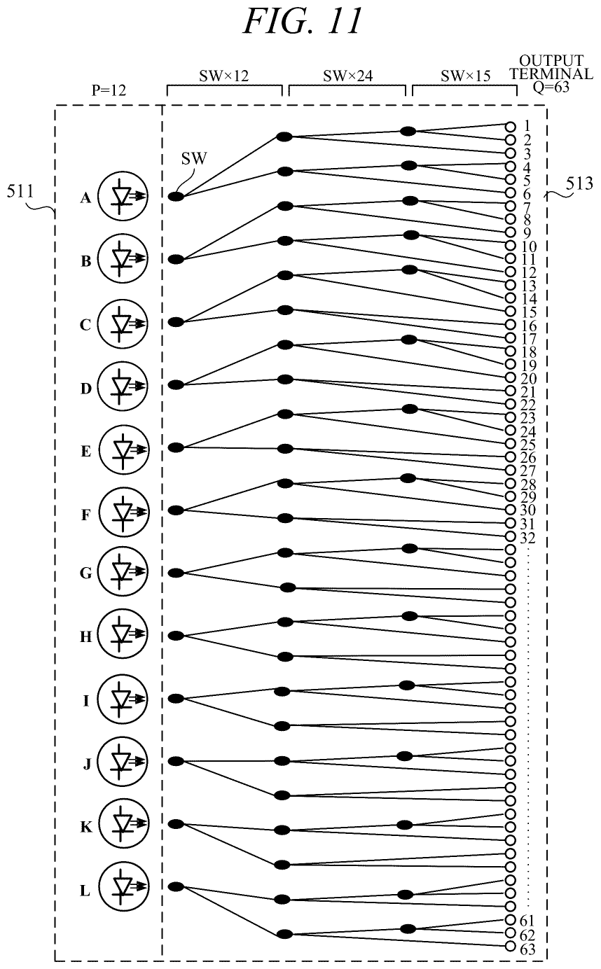

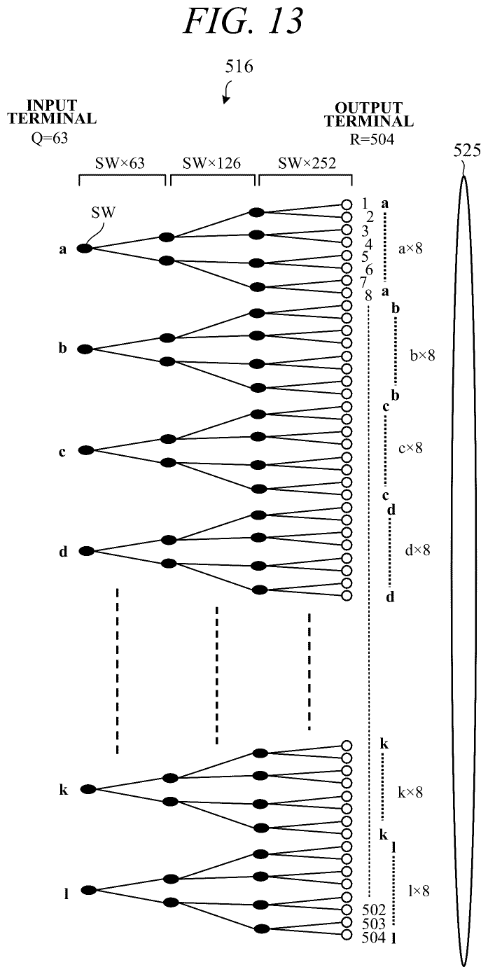

The configuration of each unit will be described in more detail with reference to FIGS. 11 to 13. Note that black ellipses shown in FIGS. 11 and 13 schematically represent 1×2 switches SW.

FIG. 11 is a diagram for explaining the light source 511 and the first switch group 513 in the diagram of the overall configuration of the transmission light branching unit exemplified in FIG. 6.

The light source 511 is a P=12 ch light source including a laser A, a laser B, a laser C, . . . , a laser K, and a laser L.

The first switch group 513 is configured by combining a plurality of 1×2 switches SW in a tree shape, each selectively outputting input light to one of the 2 ch output terminals. In the third modification, five 1×2 switches SW are combined for each of the three lasers A, B, and L. As a result, each of the beams (beam a, beam b and beam 1) emitted from the laser A, the laser B, and the laser L is selectively output from one of the 6 ch output terminals.

In addition, four 1×2 switches SW are combined for each of the nine lasers C, D, . . . , and K. As a result, each of the beams (beam c, beam d, . . . and beam k) emitted from the lasers C, D, . . . , and K is selectively output from one of the 5 ch output terminals.

With the above-described configuration, the first switch group 513 selectively outputs the 12 ch beams input from the light source 511 from P(=12) output terminals among Q=63(=3×6+9×5) output terminals.

Note that the twelve 1×2 switches provided at the 12 ch input terminals of the first switch group 513 will be referred to as first-layer switches SW. 24 switches provided on the right side (which may also be referred to as the downstream side) of the first-layer switches SW will be referred to as second-layer switches SW. In addition, 15 switches provided on the right side (downstream side) of the second-layer switches SW will be referred to as third-layer switches SW.

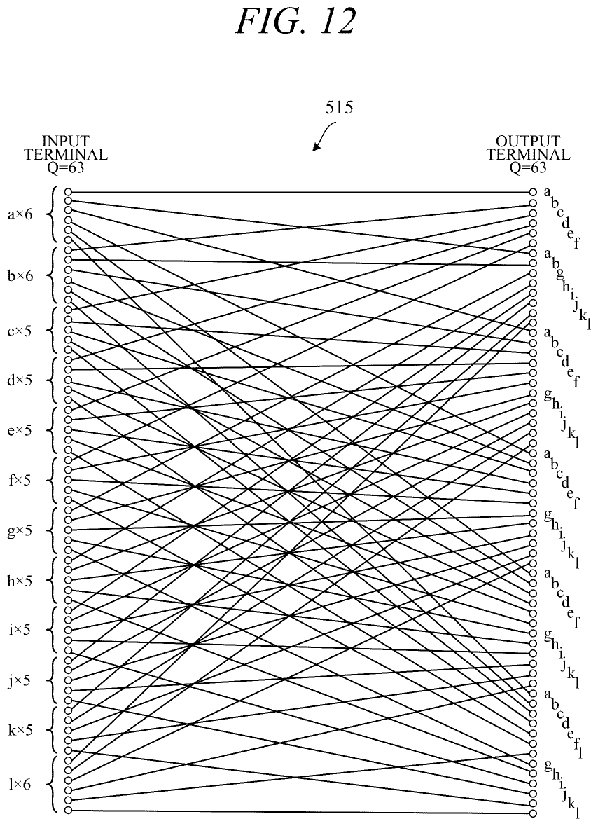

FIG. 12 is a diagram for explaining the waveguide crossing unit 515 in the diagram of the overall configuration exemplified in FIG. 6. For example, a total of 63(=6+6+9×5+6) terminals are arranged at the 63 ch input terminals of the waveguide crossing unit 515 for beams a emitted from the laser A for 6 ch, beams b emitted from the laser B for 6 ch, beams c to beams k emitted from the lasers C to K, respectively, for 5 ch, and beams l emitted from the laser L for 6 ch.

The waveguide crossing unit 515 has Q=63 ch waveguides formed on a silicon substrate. In the third modification, among the 63 ch waveguides, 61 ch waveguides excluding the uppermost 1 ch waveguide and the lowermost 1 ch waveguide in FIG. 12 are formed to cross each other on the substrate. As a result, the order in which the beams are arranged at the input terminals of the waveguide crossing unit 515 is different from the order in which the beams are arranged at the output terminals of the waveguide crossing unit 515.

A beam a, a beam b, a beam c, a beam d, a beam e, and a beam f are arranged by 1 ch, for example, for the first 6 ch output terminals among the 63 ch output terminals of the waveguide crossing unit 515. A beam a, a beam b, a beam g, a beam h, a beam i, a beam j, a beam k, and a beam 1 are arranged by 1 ch for the next 8 ch output terminals. A beam a, a beam b, a beam c, a beam d, a beam e, a beam f, a beam g, a beam h, a beam i, a beam j, a beam k, and a beam l are arranged by 1 ch for the next 12 ch output terminals.

A beam a, a beam b, a beam c, a beam d, a beam e, a beam f, a beam g, a beam h, a beam i, a beam j, a beam k, and a beam l are also arranged by 1 ch for the next 12 ch output terminals. Further, a beam a, a beam b, a beam c, a beam d, a beam e, a beam f, a beam g, a beam h, a beam i, a beam j, a beam k, and a beam l are arranged by 1 ch for the next 12 ch output terminals.

A beam a, a beam b, a beam c, a beam d, a beam e, a beam f, and a beam l are arranged by 1 ch for the next 7 ch output terminals. A beam g, a beam h, a beam i, a beam j, a beam k, and a beam l are arranged by 1 ch for the last 6 ch output terminals.

FIG. 13 is a diagram for explaining the second switch group 516 and the projection lens 525 in the diagram of the overall configuration exemplified in FIG. 6. The second switch group 516 according to the third modification substantially includes 1×s(=8) switches by combining (seven) 1×2 switches SW in three layers in a tree shape for each of the 63 ch input terminals. That is, a beam input to each of the 63 ch input terminals is selectively output from one of the corresponding 8 ch output terminals.

Among the 1×2 switches SW in the three layers provided at the 63 ch input terminals, 63 switches provided on the left side (which may also be referred to as the upstream side) in FIG. 13 will be referred to as fourth-layer switches SW. 126 switches provided on the right side (which may also be referred to as the downstream side) of the fourth-layer switches SW will be referred to as fifth-layer switches SW. In addition, 252 switches provided on the right side (downstream side) of the fifth-layer switches SW will be referred to as sixth-layer switches SW.

With the above-described configuration, the second switch group 516 having R(=504)ch output terminals is configured such that a beam input to each of the Q(=63)ch input terminals is selectively output from one of the corresponding 8 ch output terminals.

As described above, R irradiation light beams output from the R output terminals are incident on different regions of the projection lens 525. Then, the R beams are irradiated to different irradiation points in the FOV via the horizontal scanning mechanism 53.

Note that, as is clear from FIG. 13, beams a, beams b, beams c, beams d, beams e, beams f, beams g, beams h, beams i, beams j, beams k, and beams l are incident on different regions of the projection lens 525. That is, the laser A, the laser B, the laser C, the laser D, the laser E, the laser F, the laser G, the laser H, the laser I, the laser J, the laser K, and the laser L are irradiated to different irradiation points in the FOV. In other words, the laser A, the laser B, the laser C, the laser D, the laser E, the laser F, the laser G, the laser H, the laser I, the laser J, the laser K, and the laser L are irradiated to different irradiation regions in the FOV.

As described above, the vertical scanning mechanism 500 switches a position (which may also be referred to as a region) where an irradiation light beam emitted from an output terminal of the second switch group 516 is incident on the projection lens 525, by controlling the switching between the lasers emitted from the light source 511 and the switching between the optical switches of the first switch group 513 and the second switch group 516.

R irradiation light beams corresponding to R irradiation points arranged in the vertical direction in the FOV can be emitted from the R(=504)ch output terminals of the second switch group 516. In the third modification, since the number of lasers that can be emitted from the light source 511 at the same timing is 12 ch, the number of irradiation light beams that can be emitted simultaneously is 12. While switching the optical switches of the first switch group 513 and the second switch group 516, the LiDAR 5 shifts the laser emission timing in time series to sequentially emit the necessary one of the 12 ch lasers, thereby scanning the irradiation light in the vertical direction. As an example, when the 12 ch lasers are emitted in 42 separate bursts, 504 irradiation light beams aligned in the vertical direction can be emitted in the FOV.

According to the above-described third modification, the following operational effects can be obtained.

A LIDAR 5 includes a vertical scanning mechanism 500 as a first scanning unit that scans and irradiates optical signals (beam a to beam l) in a vertical direction as a first direction, and a horizontal scanning mechanism 53 as a second scanning unit that scans and irradiates optical signals (beam a to beam l) in a horizontal direction as a second direction intersecting the vertical direction, and functions as an in-vehicle detection apparatus that detects an external environment situation by scanning and irradiating the optical signals (beam a to beam l) in the FOV.

Focusing on the optical signals from the laser B and the laser C among the lasers A to L, the vertical scanning mechanism 500 as at least one of the first scanning unit and the second scanning unit includes: first optical switches (collectively referring to switches SW in first to third layers each switching an optical path of the beam b among switches of the first switch group 513), each receiving an optical signal (beam b) from the laser B as a first light source and selectively outputting the optical signal (beam b) from one of output terminals of m1 (e.g., 6) channels; second optical switches (collectively referring to switches SW in the first to third layers each switching an optical path of the beam c among switches of the first switch group 513), each receiving an optical signal (beam c) from the laser C as a second light source and selectively outputting the optical signal (beam c) from one of output terminals of m2 (e.g., 5) channels; m1 third optical switches (collectively referring to switches SW in fourth to sixth layers each switching the optical path of the beam b among switches of the second switch group 516), each receiving an optical signal (beam b) output from the first optical switch and selectively outputting the optical signal (beam b) from one of output terminals of s (e.g., 8) channels; m2 fourth optical switches (collectively referring to switches SW in the fourth to sixth layers each switching the optical path of the beam c among switches of the second switch group 516), each receiving an optical signal (beam c) output from the second optical switch and selectively outputting the optical signal (beam c) from one of output terminals of s (e.g., 8) channels; and a waveguide crossing unit 515 as a waveguide-type crossing unit that crosses at least some optical signals among the optical signals (beams b) output from the first optical switches and the optical signals (beams c) output from the second optical switches.

In particular, by including the waveguide crossing unit 515 that crosses the optical signals (beams b and beams c), the vertical scanning mechanism 500 can output the optical signals (beam b or beam c) after being crossed by the waveguide crossing unit 515. As a result, the optical signals (beams b and beams c) output from the vertical scanning mechanism 500 can be made dense as compared with those in a case where the waveguide crossing unit 515 is not provided. More specifically, by switching the order in which the optical signals output from output terminals of the vertical scanning mechanism 500 are arranged, for example, the terminal from which the beam b is output and the terminal from which the beam c is output can be brought close to each other, or the positional relationship between the terminals from which the beam b and the beam c are output can be shifted.

If a multilayer optical switch such as an integrated optical switch is combined with a conventional technology (a configuration in which a plurality of demultiplexing elements are merely stacked), even though optical signals output from output terminals of the integrated optical switch can be made dense, the excessively large size of the integrated optical switch hinders a reduction in size of the LiDAR. Furthermore, the internal loss of the integrated optical switch reduces power of irradiation light, making it difficult to satisfy the requirements (in particular, small size and long-distance measurement) as the in-vehicle detection apparatus.

However, the LiDAR 5 according to the embodiment, which is not affected by the size of the integrated optical switch and the internal loss of the integrated optical switch, can realize size reduction and long-distance measurement as an in-vehicle detection apparatus.

The above embodiment can be combined as desired with one or more of the above modifications. The modifications can also be combined with one another.

According to the present invention, it is possible to satisfy the requirements as an in-vehicle detection apparatus.

Above, while the present invention has been described with reference to the preferred embodiments thereof, it will be understood, by those skilled in the art, that various changes and modifications may be made thereto without departing from the scope of the appended claims.

What is claimed is:

1. An in-vehicle detection apparatus comprising a first scanning unit configured to scan and irradiate optical signals in a first direction, and a second scanning unit to scan and irradiate optical signals in a second direction intersecting the first direction, and configured to detect an external environment situation by scanning and irradiating the optical signals in a field of view, wherein
at least one of the first scanning unit and the second scanning unit comprises:
a first optical branching unit configured to selectively switch a destination to which each of the optical signals from a plurality of light sources is output to one of output destinations of a plurality of channels;
a crossing unit configured to cross at least some optical signals among the optical signals output from the first optical branching unit; and
a second optical branching unit configured to receive the optical signals output from the crossing unit, and selectively switch a destination to which each of the optical signals is output to one of output destinations of a plurality of channels.

2. The in-vehicle detection apparatus according to claim 1, wherein
the first optical branching unit comprises:
first optical switches configured to receive an optical signal from a first light source and selectively output the optical signal from one of output destinations of a first predetermined number of channels; and
second optical switches configured to receive an optical signal from a second light source and selectively output the optical signal from one of output destinations of channels of a second predetermined number,
the crossing unit crosses at least some optical signals among the optical signals output from the first optical switches and the optical signals output from the second optical switches, and
the second optical branching unit comprises:
the first predetermined number of third optical switches, each configured to receive the optical signal output from the first optical switches among the optical signals output from the crossing unit and selectively output the optical signal from one of output destinations of a third predetermined number of channels; and
the second predetermined number of fourth optical switches, each configured to receive the optical signal output from the second optical switches among the optical signals output from the crossing unit and selectively output the optical signal from one of output destinations of the third predetermined number of channels.

3. The in-vehicle detection apparatus according to claim 2, wherein
the crossing unit comprises a plurality of input terminals and a plurality of output terminals,
the plurality of input terminals includes input terminals of the first predetermined number of channels to which the optical signals from the first light source are input and input terminals of the second predetermined number of channels to which the optical signals from the second light source are input,
the plurality of output terminals includes output terminals of the first predetermined number of channels which output the optical signals from the first light source and output terminals of the second predetermined number of channels which output the optical signals from the second light source, and
the crossing unit crosses the optical signals such that the optical signals input to channels which are adjacent to each other at the input terminals of the plurality of channels are output from channels which are not adjacent to each other at the output terminals of the plurality of channels.

4. The in-vehicle detection apparatus according to claim 2, wherein
the crossing unit is provided between the first and second optical switches and the third and fourth optical switches.

5. The in-vehicle detection apparatus according to claim 4 further comprising
a microprocessor and a memory connected to the microprocessor, wherein
the microprocessor is configured to perform:
outputting control signals to the first optical switches and the third optical switches such that an optical signal from the first light source is projected to a first region in the field of view; and
outputting control signals to the second optical switches and the fourth optical switches such that an optical signal from the second light source is projected to the second region in the field of view at a same timing as the optical signal projected to the first region.

6. The in-vehicle detection apparatus according to claim 5, wherein
the microprocessor is configured to perform:
outputting control signals to the first optical switches and the third optical switches such that the optical signal from the first light source is further projected to a third region in the field of view at a timing different from a timing at which the optical signal from the first light source is projected to the first region; and
outputting control signals to the second optical switches and the fourth optical switches such that the optical signal from the second light source is further projected to a fourth region in the field of view at a timing which is the same as the timing at which the optical signal from the first light source is projected to the third region and at a timing which is different from the timing at which the optical signal from the second light source is projected to the second region.

7. The in-vehicle detection apparatus according to claim 6, wherein
the microprocessor is configured to perform:
outputting control signals to the first optical switches and the third optical switches such that the optical signal from the first light source is further projected to a fifth region in the field of view at a timing different from a timing at which the optical signal from the first light source is projected to the first region and the third region; and
outputting control signals to the first optical switches and the third optical switches such that the optical signal from the second light source is further projected to a sixth region in the field of view at a timing which is the same as the timing at which the optical signal from the first light source is projected to the fifth region and at a timing which is different from the timing at which the optical signal from the second light source is projected to the second region and the fourth region.

8. The in-vehicle detection apparatus according to claim 1, wherein
the first optical branching unit comprises:
first optical switches configured to receive an optical signal from a first light source and selectively output the optical signal from one of output destinations of a fourth predetermined number of channels; and
second optical switches configured to receive an optical signal from a second light source and selectively output the optical signal from one of output destinations of channels of a fifth predetermined number different from the fourth predetermined number,
the crossing unit crosses at least some optical signals among the optical signals output from the first optical switches and the optical signals output from the second optical switches, and
the second optical branching unit comprises:
the fourth predetermined number of third optical switches, each configured to receive the optical signal output from the first optical switches among the optical signals output from the crossing unit and selectively output the optical signal from one of output destinations of a sixth predetermined number of channels; and
the fifth predetermined number of fourth optical switches, each configured to receive the optical signal output from the second optical switches among the optical signals output from the crossing unit and selectively output the optical signal from one of output destinations of the sixth predetermined number of channels.

9. The in-vehicle detection apparatus according to claim 1, wherein
the first direction is a vertical direction, and
the second direction is a horizontal direction.
